(19) United States
(12) Patent Application Publication
(10) Pub. No.: US 2002/0082913 A1
(43) Pub. Date: Jun. 27, 2002

(54) Advertising enabled digital content

(76) Inventor: Weijun Li, Sunnyvale, CA (US)

Correspondence Address: ANTHONY T. CASCIO, ESQ,, BURNS, DOANE, SWECKER & MATHIS, L.L.P., P.O. Box 1404, Alexandria, VA, 22313-1404, US

(21) Appl. No.: 09/747,775

(22) Filed: Dec. 22, 2000

(51) Int. Cl. G06F 17/60

(52) U.S. Cl. 705/14

(57) ABSTRACT

Electronic content distributed freely over the Internet may be subsidized by the attachment of advertising presented to an end user when using the content with an executable program. The electronic content has associated therewith a user right which is determined by the executable player. An executable module attached to the executable program obtains at least one electronic advertisement in the event the user right is indicative of a restricted right. The electronic advertisement may be obtained from a advertising server and presented to the user, visually or audibly, during the use of the program acting upon the content.

### FIELD OF THE INVENTION

The present invention relates generally to a method for enabling digital content with advertisements, and, more particularly, to a method for visually or audibly presenting advertisements to consumers of concurrently with the use of digital content streamed or downloaded from a public computer network.

### BACKGROUND OF THE INVENTION

A material portion of electronic content available on the Internet for accessing and downloading from numerous web sites is freely distributed without restriction on use or copying. As used herein, content refers generally to the electronic data contained within data files of any type of format. More specifically, content is the data in a file accessed by an executable program. Although such content may be free to the end user accessing and downloading such content, the revenue required for continuous web site operations at any such web site wherein such content is available, both for maintaining existing content libraries and obtaining new content, may be provided in part by one or more advertisers.

As in any form of traditional media advertising, the advertisers purchasing advertising space at the web sites, at which such content may be located, attempt to focus their advertisements to the demographics of the target audience of the web site. In turn, this target audience should be motivated by the advertisements to purchase the advertised goods and services as well as ancillary goods and services. Should the advertisements be effective in reaching the target audience, the revenues from the increase in sales generated by the advertisements should support the expense of purchasing the advertising space. In any event, it is contemplated that the users viewing the advertisements will be induced, in addition to using the freely available content, to purchase the goods and services from the merchants identified in the advertisements.

The most common form of Internet advertising is the placement of advertisements directly on a web page containing the source for the desired content. Typically, such advertisement is a digital image anchored to a server address so that a user by clicking on the advertisement will be redirected to another web site to obtain more information on the advertised good or service, and ideally purchase. However, a disadvantage and limitation of such advertisements is that they are generally passive and, in the event of numerous advertisements placed on a single page, may be readily ignored by the user accessing the page, and possibly not even seen if the user may obtain the desired content from an initial portion of the web page and the advertisement could only be viewed if the user needed to scroll the page downward to obtain the desired content.

In an attempt to make advertising more effective, advertisers have tagged the HTML web pages so that instead of a static advertisement being placed on the web page, an additional window, commonly referred to as a pop-up, is displayed on the user interface containing the advertisement. The use of the pop-up tends to direct the focus of the user to the new pop-up, which is automatically layered on top of the main browser window or page. The advertiser then relies upon the user at least momentarily viewing the advertisement prior to closing the pop-up window so that the main page then may be read. However, a disadvantage and limitation of the pop-up window is that a user may anticipate the pop-up window as containing an advertisement and may be induced to close the pop-up window prior to the actual advertisement being loaded. Accordingly, the advertiser has paid for advertising space that a user may effectively block from ever being seen.

Through the use of Internet advertising, Internet access service itself has even been made available without cost to the user in exchange for the user being forced to have streaming advertisements prominently displayed in the user interface in addition to the desired web page. For example, one such Internet access service is commercially available under the NetZero service mark. To use this service, the user must first download, or otherwise obtain a copy of, a dial up manager that connects and authenticates the user to the service. The dial-up manager also contains a module that connects to an advertising server for the receipt of the streaming ads. Once the user is connected to the ISP host and also to the advertising server, the default browser in the user computer is launched by the dial up manager. The dial up manager may also control the size of the browser window such that the banner for the streaming ads is viewed separately from the web page so that there is no obliteration of the page, yet maintain the advertisements in a prominent location within the user interface. Although streaming advertisement is always prominently featured on the user interface, such advertisement is used typically to support the cost of providing the Internet access service and not the cost of providing content that could be downloaded from any of the web pages that may be viewed.

It is known that a software application, downloadable from the Internet, may have the cost of developing its proprietary code supported or subsidized by advertising revenues. In commonly owned, copending application Ser. No. 09/053,949, there is disclosed a method and apparatus enabling the presentation of advertisement in the user interface when a user has launched a freely obtained, or reduced cost, version of a software application executing on the user computer. As disclosed therein, a code module is injected into the software application, without making substantial revision to the source code, such that upon launching the application, the code module is first executed to connect with an advertising server such that advertisements may be displayed while the user is running the software application. If the connection fails, the software may not be executed. Should the end user make a copy of the code injected software and distribute it to another, the subsequent user will also need to be connected to the advertising server. Thus, the publisher or distributor of the software need not care about an end user making unauthorized copies, since such copies are supported by the increase in advertising revenues generated from the ads streamed to the subsequent user.

However, none of the above advertising models support the presentation of advertisements to end users when the downloaded content is actually being used. Yet it may be during the use of the content that the advertisement may be most effective in reaching the target audience. For example, a user may have downloaded several free mp3 encoded files from a web site containing advertising. The user may have, through familiarity with the web site, been able to obtain expeditiously the content while ignoring the advertisements placed in the web page. The user may now play these files through an mp3 player, and make further copies for distribution to other users. The advertisement is accordingly never viewed by these subsequent users. Accordingly, the advertisement may be ineffective in generating sufficient revenues to support such web site.

An advertised enabled mp3 player, based upon the advertising enabled software model described above, may also be disadvantageously limited in generating sufficient revenues to support such a web site. When the mp3 files downloaded from the web site are played through the advertising enabled player, the user interface will display the streaming advertisements. However, there is no restriction that the user, or any subsequent user a copy of the mp3 file, need use an advertising enabled player, thus depriving the advertiser of having the advertisement viewed and possibly inducing a purchase of the advertised good or service. Furthermore, since not all mp3 files are freely distributed, but may need to be paid for, a user paying for an mp3 file would not be motivated to use an advertising enabled player, and may even consider the requirement of being presented with advertisements as objectionable after purchase of an unrestricted license to the content.

Accordingly, there exists a need to target any end user with advertisements when using freely distribute content wherein the advertisements are not dependent on the player being advertising enabled. There exists a further need to have the advertisements be presented whenever any copy of the content is being used. Additionally, there exists a need to remove such advertisements if the user has paid for an unrestricted license to the content.

### SUMMARY OF THE INVENTION

It is an object of the present invention to overcome one or more disadvantages and limitations of the prior art hereinabove enumerated.

It is a further object of the present invention to target any end user with advertisements when using freely distributed content wherein the advertisements are not dependent on the player being advertising enabled.

It is a another object of the present invention to have the advertisements be presented whenever any copy of the content is being used.

It is yet another object of the present invention to remove such advertisements if the user has paid for an unrestricted license to the content.

According to the present invention, electronic content distributed freely over the Internet may be subsidized by the attachment of advertising presented to an end user when using the content with an executable program. The electronic content has associated therewith a user right which is determined by the executable player. An executable module attached to the executable program obtains at least one electronic advertisement in the event the user right is indicative of a restricted right.

One feature of the present invention is that the electronic advertisement may be obtained from a advertising server and presented to the user, visually or audibly, during the use of the program acting upon the content. For example, audio mp3 files with the associated user right may be freely downloadable. The user may then store in an mp3 player a play list of the downloaded mp3 files. If the mp3 player has the attached executable module of the present invention, and the mp3 files will be capable of being played. The mp3 player determines the user right, and if restricted, will invoke the executable module to obtain electron advertisements in mp3 format from an ad server to be presented to the user. The advertisements themselves may be played at periodic intervals, for example, one advertisement played prior to each mp3 file being played. Similarly, if the content is visual, while a video player is displaying the content on the computer monitor, the executable module would be connected to an ad server continuously obtaining visual advertisements presented in a separate window.

These and other objects, advantages and features of the present invention will become readily apparent to those skilled in the art form a study of the following Specification when read in conjunction with the attached Drawing and the appended Claims.

### BRIEF DESCRIPTION OF THE DRAWING

FIG. 1 is a block diagram of a system useful to practice the methods of the present invention;

FIG. 2 is a functional block diagram of the system of FIG. 1; and

FIG. 3 is a flow chart of the methods of the present invention.

### DESCRIPTION OF THE EXEMPLARY PREFERRED EMBODIMENTS

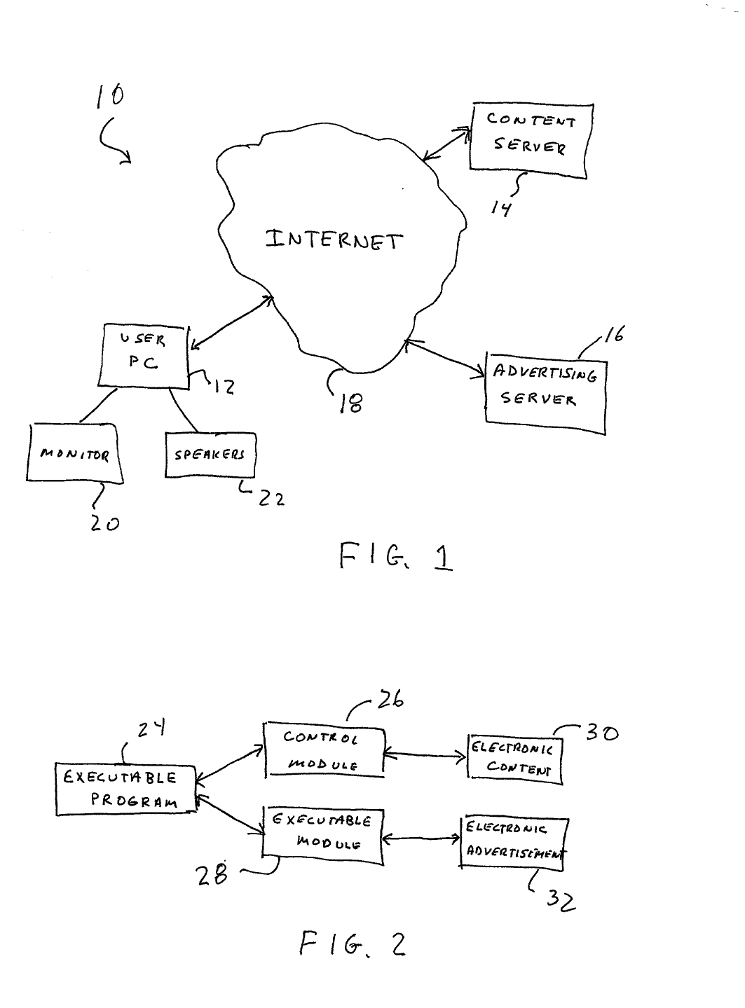

Referring now to FIG. 1, there is shown a network 10. Network 10 includes a user computer 12, at least one content server 14 and at least one advertising server 16. The user computer 12, the content server 14 and the advertising server 16 are connected for selective communication to each other through a public computer network 18, such as the Internet. The user computer 12 includes a video monitor 20, to provide a video user interface, and speakers 22, to provide an audio user interface.

With further reference to FIG. 2, the user computer 12 includes an executable program 24. The executable program 24 may be any type of program which requires calls to be made for electronically stored data during processing of the program code. For example, the executable program 24 may be any type of audio or video media player, game player or the like, although any type of program may be used in accordance with the present invention. Attached to the executable program 24 are a control module 26 and an executable module 28.

The control module 26 may preferably take the form of code injected into the executable program 24 using techniques practiced in the art or as described more fully in U.S. Pat. No. 6,044,469, incorporated herein by reference. The control module 26 may take the form of a shared library, such as a Dynamic Link Library (DLL) used in the Microsoft Corporation Windows™ operating system. Alternatively, the protection module may take the form of API calls inserted into the original source code of the executable program 24. Still other types of protection modules will be apparent to one of ordinary skill in the art.

Similarly, the executable module 28 may also take the form of code injected into the executable program 24. The executable module 28 functions to retrieve and present to the user of the executable program 24 various advertisements as more fully described in commonly owned, copending application Ser. No. 09/053,949, incorporated herein by reference. However, whereas in the prior application the executable module is launched upon the user opening the executable program 24, the executable module 28, in accordance with the present invention, is launched upon a determination, as more fully described below.

The content server 14 stores electronic content 30, such as text files, video files, audio files, game files and the like. The electronic content 30 may be selectively downloaded by a user of user computer 12 and stored at the user computer 12, in individual files or in play list using known functions of a media player, or streamed through a socket connection from the content server 14 to the user computer 12 during the running of the executable program 24.

The advertising server 16 stores electronic advertisements 32, which may be provided in any of audio, graphic or video formats. The advertising server may also retrieve electronic advertisements from other sources in the Internet 18, as described in the aforementioned application incorporated herein.

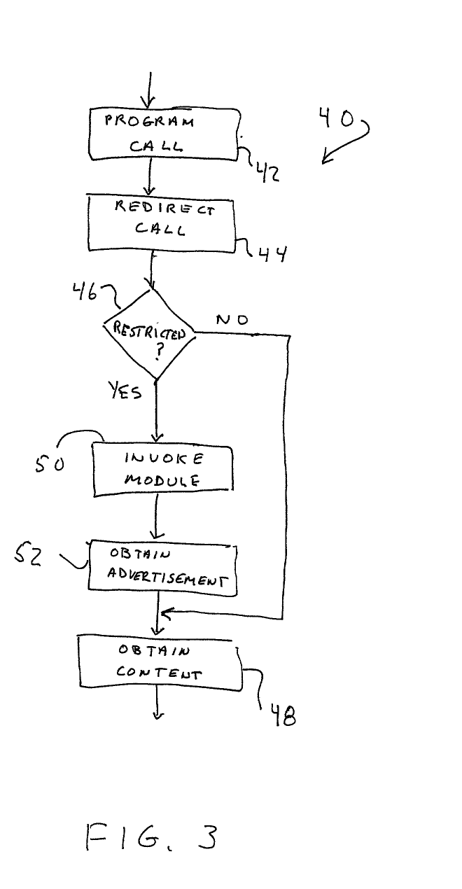

Referring now to FIG. 3, there is shown a flowchart 40 descriptive of the sequence of operations within the system 10 described above. Initially, the executable program 24 makes a call for the electronic content 30, as indicated at 42. The electronic content may reside locally at the user computer 12, or in the content server 14. In response to the call being made, the call is redirected to the control module 26, as indicated at 44. The control module then determines a user right in the electronic content 30, as indicated at 46. If the user right to the electronic content 30 is unrestricted, as indicated by the NO path, then the control module 26 obtains the electronic content, as indicated at 48. However, if the user right to the electronic content is restricted, as indicated by the YES path, the below described sequence is performed. To obtain the electronic content 30, the control module 26 functions as described in commonly owned, co-pending application Ser. No. 09/675,566, incorporated herein by reference.

In the event the YES path is taken, as indicated at 50, the executable module 28 is invoked to obtain at least one electronic advertisement from advertising server 16. The control module 26 preferably invokes the executable module 28, although the invoking can also be performed by the executable program 24. In either event, the electronic advertisement is obtained, as indicated at 52. To retrieve the electronic advertisements, the remote advertising server 16 is connected to, the electronic advertisements received and presented to the user at the user computer 12. The presentation may be displayed through the monitor 20, if the advertisements are graphics or streaming video, or played through the speakers 22, if the advertisements are audio.

In one embodiment of the present invention, the electronic advertisements may be presented occasionally or intermittently to the user of the user computer 12. For example, if the executable program 24 is an mp3 player, and the electronic content 30 is either a locally stored play list of mp3 files or streaming mp3 data, the advertisements 32 themselves may be played through the speakers 22 at periodic intervals, for example, one advertisement 32 played prior to each mp3 file being played.

Similarly, if the content 30 is visual, and the executable program 24 is a video player is displaying the content 30 on the computer monitor 20, the executable module would be connected to an ad server continuously obtaining visual advertisements presented in a separate window.

Alternatively to the hereinabove described embodiments, instead of the executable module 28 directly obtaining the electronic advertisement 32, the executable module 28 could launch the execution of a web browser in the user computer 12. The browser would then connect to the advertising server 16 to display the advertisements 32 in a the browser window, or in a pop-up, or a banner.

There has been described hereinabove exemplary preferred embodiments of the present invention. Those skilled in the art may now make numerous uses of, and departures from, the hereinabove described embodiments without departing from the inventive concepts described herein. Accordingly, the present invention is to be defined solely by the scope of the appended Claims.

What is claimed as the invention is:

1. A method for advertising enabling electronic content comprising: providing said electronic content to an executable program adapted to read said electronic content, said electronic content having associated therewith a user right;
determining said user right in said content; and
invoking an executable module attached to said executable program to obtain at least one electronic advertisement in the event said user right is indicative of a restricted right.

2. A method as set forth in claim 1 wherein said invoking step includes:
connecting to a remote advertisement server;
receiving said electronic advertisement; and
presenting said electronic advertisement to a user.

3. A method as set forth in claim 2 wherein said executable module connects to said server.

4. A method as set forth in claim 2 wherein said executable module causes execution of a web browser program to connect to said server.

5. A method as set forth in claim 2, wherein said advertisement is presented to said user at least occasionally, but during at least certain other times, no advertisement is presented.

6. A method as set forth in claim 2 wherein said presenting includes displaying said advertisement on video user interface.

7. A method as set forth in claim 2 wherein said presenting includes playing said advertisement through an audio user interface.

8. A method as set forth in claim 2 wherein said advertisement is a sequence of advertisements presented substantially throughout use of said executable program.

9. A method as set forth in claim 2 wherein said advertisement is presented at periodic intervals.

10. A method as set forth in claim 1 wherein said determining includes:
controlling the execution environment of said executable program with a control module such that a call made by said executable program to file access functions to obtain said electronic content is first directed to said control module;
determining by said control module said user right, said executable module being invoked by said control module in the event said restricted right is indicated;
making said call by said control module;
obtaining said content by said control module; and
transmitting said content to said executable program through said control module.

11. A method as set forth in claim 10 further comprising:
encrypting said content; and
decrypting said content substantially concurrently with said obtaining step.

12. A method as set forth in claim 1 wherein said executable program is a media player.

13. A method as set forth in claim 1 wherein said executable module is a shared library.

14. A method as set forth in claim 1 wherein said call is made to content residing on a computer network.

15. A method as set forth in claim 1 wherein said call is made to content provided through a streaming socket connection.

16. A method for advertising enabling electronic content comprising:
controlling the execution environment of an executable program with a control module such that a call made by said executable program to file access functions to obtain said electronic content is first directed to said control module;
determining by said control module a user right of said electronic content;
invoking by said control module an executable module attached to said executable program to obtain at least one electronic advertisement in the event said restricted right is indicated;
making said call by said control module;
obtaining said electronic content by said control module; and
transmitting said content to said executable program through said control module.

17. A method as set forth in claim 16 wherein said invoking step includes:
connecting to a remote advertisement server;
receiving said electronic advertisement; and
presenting said electronic advertisement to a user.

18. A method as set forth in claim 17 wherein said executable module connects to said server.

19. A method as set forth in claim 17 wherein said executable module causes execution of a web browser program to connect to said server.

20. A method as set forth in claim 17 wherein said advertisement is presented to said user at least occasionally, but during at least certain other times, no advertisement is presented.

21. A method as set forth in claim 17 wherein said presenting includes displaying said advertisement on video user interface.

22. A method as set forth in claim 17 wherein said presenting includes playing said advertisement through an audio user interface.

23. A method as set forth in claim 17 wherein said advertisement is a sequence of advertisements presented substantially throughout use of said executable program.

24. A method as set forth in claim 17 wherein said advertisement is presented at periodic intervals.

25. A method as set forth in claim 16 further comprising:
encrypting said content; and
decrypting said content substantially concurrently with said obtaining step.

26. A method as set forth in claim 16 wherein said executable program is a media player.

27. A method as set forth in claim 16 wherein said executable module is a shared library.

28. A method as set forth in claim 16 wherein said call is made to content residing on a computer network.

29. A method as set forth in claim 16 wherein said call is made to content provided through a streaming socket connection.
